(19) United States
(12) Patent Application Publication
(10) Pub. No.: US 2026/0144380 A1
(43) Pub. Date: May 28, 2026

(54) MANUFACTURE METHOD OF WOVEN SURFACE BY WAY OF CLEATS ATTACHMENT

(71) Applicant: FOSHAN SHUNDE ARGO PRODUCT DESIGN & DEVELOPMENT CO., LTD, FOSHAN (CN)

(72) Inventor: MARTIN DE BLOIS, SAN DIEGO, CA (US)

(21) Appl. No.: 19/031,400

(22) Filed: Jan. 18, 2025

(30) Foreign Application Priority Data
Nov. 25, 2024 (CN) 202411693737.6

(51) Int. Cl. D03D 3/08; A47C 7/22; D03D 15/46

(52) U.S. Cl. CPC A47C 7/22; D10B 2505/08

(57) ABSTRACT

A manufacture method of a woven surface by a way of cleats attachment includes steps A-D. The step A includes providing a frame, where an interior of the frame is hollow to define a weaving area. The step B includes fixing a shaping mold on the frame, where a shaping surface of the shaping mold extends into the weaving area. The step C includes weaving the non-flat wove surface on the frame by using weaving strips and enabling a bottom portion of the non-flat wove surface being tightly attached to the shaping surface of the shaping mold. The step D includes disassembling the shaping mold after the non-flat wove surface is completely woven. By disposing the shaping mold in the frame, the weaving strips are closely attached to the shaping surface of the shaping mold for weaving, thereby forming a three-dimensional woven layer.

### TECHNICAL FIELD

The present disclosure relates to a technical field of rattan weaving, and in particular to a manufacture method of a woven surface by a way of cleats attachment.

### BACKGROUND

Natural weaving materials, such as rattan and bamboo strips, have long been widely used in production of furniture, decorations, and other products due to their flexibility and plasticity. Nowadays, plastic rattan is also used for weaving. Conventional weaving technology mainly relies on manual operations. Craftsmen weave flat woven structures with a certain strength and toughness by staggering the weaving strips. The flat woven structures are widely used in products such as tables, chairs, screens, and baskets. Because the flat woven structures are simple to make and the weaving strips are easily obtained, the flat woven structures become a common form in many daily necessities.

However, with increasing demands of customers for aesthetics and personalization of home decoration and daily necessities, conventional flat woven products gradually expose some defects that cannot be ignored.

First, lack of three-dimensional effect is a main defect of the conventional woven products. Since a conventional weaving process is commonly performed on a two-dimensional plane, a finished woven product generally presents a two-dimensional flat structure. The flat structure is relatively monotonous visually, and it is difficult to create a rich sense of spatial hierarchy and three-dimensionality, making the conventional flat woven products appear rather dull and lacking in variety in design.

Secondly, limited design is also a significant defect of a conventional flat woven products. In the prior art, the craftsmen have tried to enhance aesthetics of the conventional flat woven products by increasing a weaving density or adding decorative elements to a flat weaving surface of the conventional flat woven products. However, these methods only make improvements on the two-dimensional plane and cannot achieve real three-dimensional modeling. When it is necessary to produce woven products with complex three-dimensional shapes, it is difficult to ensure that the weaving strips are woven into a complex shape as desired by the conventional weaving process, resulting in unsatisfactory finished product effects.

In addition, low production efficiency is also a major defect of conventional weaving technology. In order to achieve certain specific shapes or effects of the woven products, the craftsmen have to rely on the manual operations, such as constantly adjusting the weaving structure or manually folding the weaving structure to form a three-dimensional structure. However, the manual operations are not only complicated and time-consuming, but also difficult to apply in mass production, resulting in high production costs for three-dimensional woven products, and it is difficult to ensure quality and consistency. Therefore, it is necessary to make further improvements.

### SUMMARY

A purpose of the present disclosure is to overcome defects in the prior art and provide a manufacture method of a woven surface by a way of cleats attachment. The non-flat wove surface has characteristics of simple structure, convenient use, and an ability to achieve complex three-dimensional shapes, thereby improving overall aesthetics and market competitiveness of woven products using the non-flat wove surface.

To achieve the above purpose, the present disclosure provides the manufacture method of the woven surface by the way of cleats attachment. The manufacture method comprises steps A-D. The step A comprises providing a frame, where an interior of the frame is hollow to define a weaving area.

The step B comprises fixing a shaping mold on the frame, where a shaping surface of the shaping mold extends into the weaving area.

The step C comprises weaving the non-flat wove surface on the frame by using weaving strips and enabling a bottom portion of the non-flat wove surface being tightly attached to the shaping surface of the shaping mold.

The step D comprises disassembling the shaping mold after the non-flat wove surface is completely woven.

Furthermore, the shaping mold comprises a positioning plate and shaping plates fixed to the positioning plate. Each two adjacent shaping plates are spaced apart from each other. End surfaces of the shaping plates are shaping base surfaces. The shaping base surfaces of the shaping plates jointly form the shaping surface of the shaping mold.

Furthermore, in the step C, a vertical structure perpendicular to an extending direction of the shaping plates is woven first, and then a parallel structure parallel to the extending direction of the shaping plates is woven.

Furthermore, the parallel structure and the vertical structure of the non-flat wove surface are woven together by a pick-press-weave method.

Furthermore, in the step C, the weaving strips wraps a main body of the frame.

Furthermore, hook seats are disposed on a bottom portion of the frame, and the weaving strips are wound around the hook seats.

Furthermore, through holes are defined in a bottom portion of the frame, and the weaving strips pass through the through holes for weaving.

Furthermore, a comb rack is disposed on a bottom portion of the frame, and the weaving strips are woven around teeth on the comb rack.

Furthermore, when weaving the parallel structure of the non-flat wove surface, each of the weaving strips of the parallel structure is woven between a gap defined by each two adjacent shaping plates.

The present disclosure provides the method for producing the non-flat wove surface having a three-dimensional effect by fixing the shaping mold on the frame and weaving the non-flat wove surface on the shaping mold by using the weaving strips. Compared with the prior art, the present disclosure has following significant technical characteristics.

In the present disclosure, by disposing the shaping mold in the frame, the weaving strips are closely attached to the surface of the shaping mold for weaving, thereby forming a three-dimensional woven layer. The manufacture method breaks through a limitation that conventional weaving technology is only capable of manufacturing a flat woven structure, and woven products with complex three-dimensional shapes are able to be manufactured by the present disclosure, which greatly improves aesthetics and design diversity of the woven products.

The manufacture method of the present disclosure allows the weaving strips to be interwoven in various directions, thereby forming the non-flat wove surface with a rich sense of spatial hierarchy. A spatial sense of the non-flat wove surface not only enhances a visual effect of the woven products, but also gives the woven products more functionality, such as better ventilation and breathability.

In the present disclosure, by pre-setting the shaping mold, manual operation steps in a weaving process are simplified. Compared with a conventional method of manually folding and adjusting a flat-plate weaving structure, the present disclosure improves efficiency of the weaving process while ensuring the quality of the woven products, and is more suitable for large-scale production applications. The present disclosure not only reduces production costs, but also improves the consistency and quality control level of the woven products.

Since the shaping mold is configured to determine a final shape of the non-flat wove surface during the weaving process, after the weaving process is completed, it is only necessary to simply disassemble the shaping mold without complicated post-adjustment or trimming work, which greatly simplifies the production process and improves overall production efficiency.

### BRIEF DESCRIPTION OF DRAWINGS

FIG. 1 is a schematic diagram showing an effect of a manufacture method of the present disclosure being applied to a chair.

FIG. 2 is an enlarged schematic diagram of portion A shown in FIG. 1.

FIG. 3 is a structural schematic diagram of a shaping mold of the present disclosure.

FIG. 4 is another structural schematic diagram of a shaping mold of the present disclosure.

FIG. 5 is a structural schematic diagram of a vertical structure woven on the shaping mold of the present disclosure.

FIG. 6 is a structural schematic diagram of the vertical structure and a parallel structure woven on the shaping mold of the present disclosure.

FIG. 7 is an enlarged schematic diagram of portion B shown in FIG. 5.

FIG. 8 is a schematic diagram of a comb rack of the present disclosure.

FIG. 9 is a schematic diagram of a hook seat of the present disclosure.

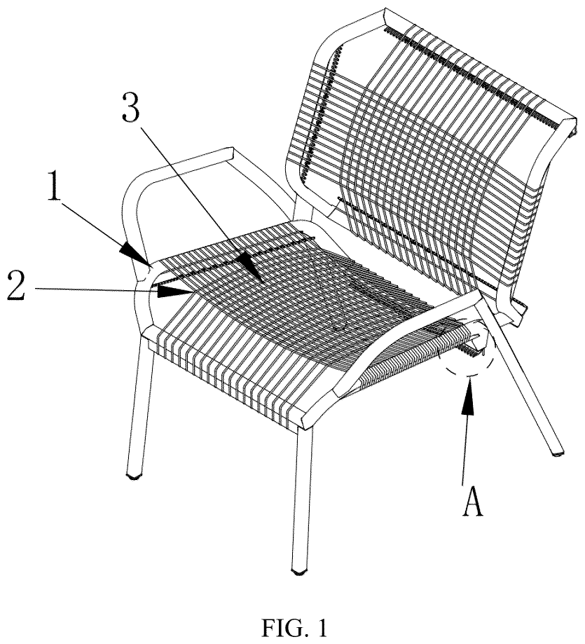

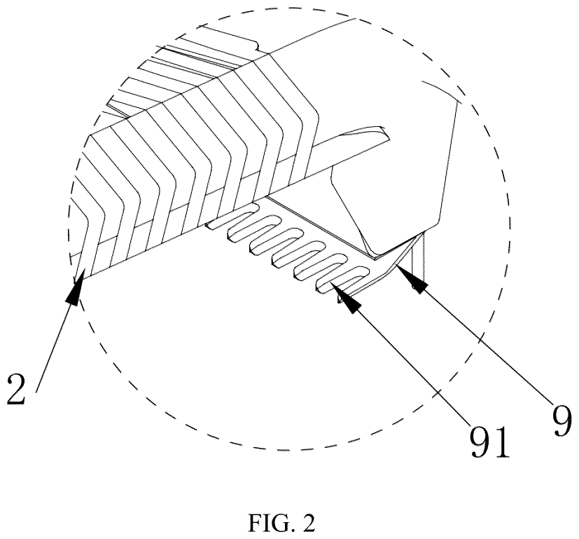

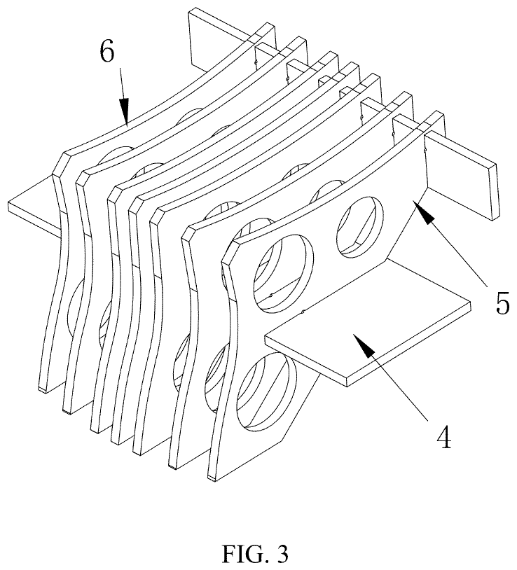

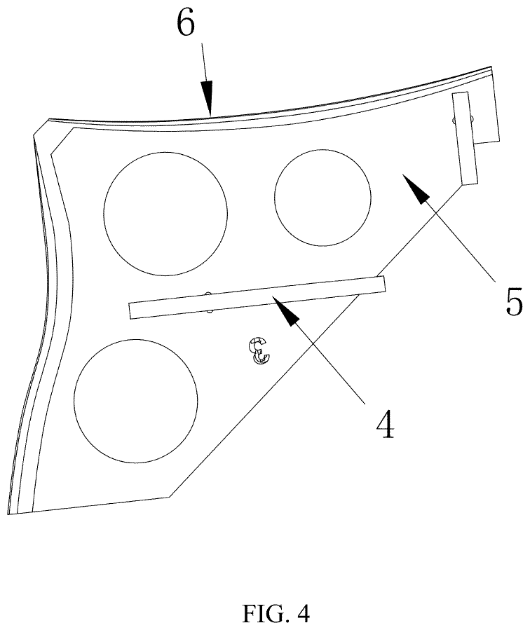

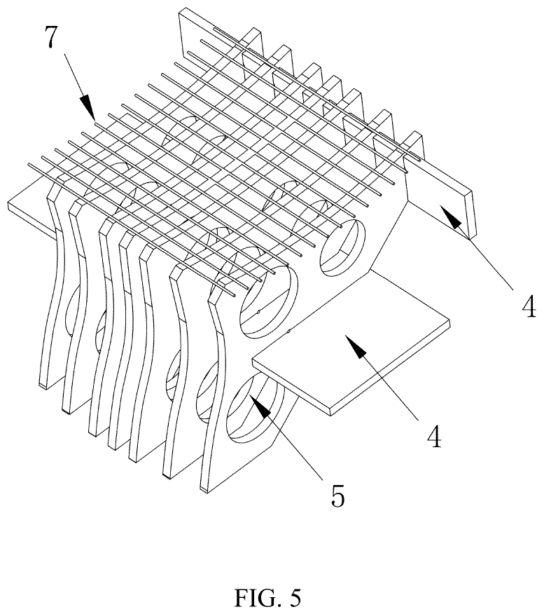

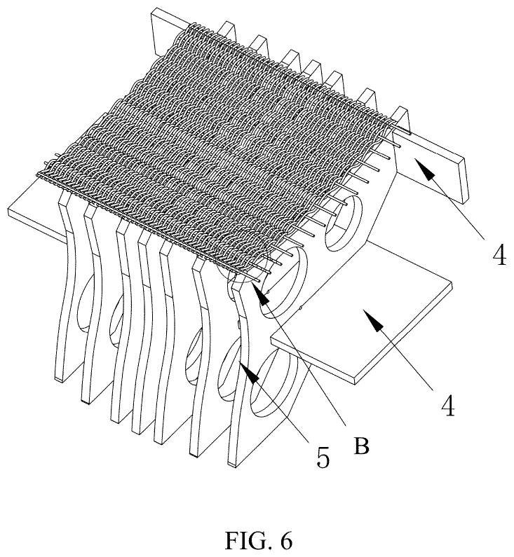

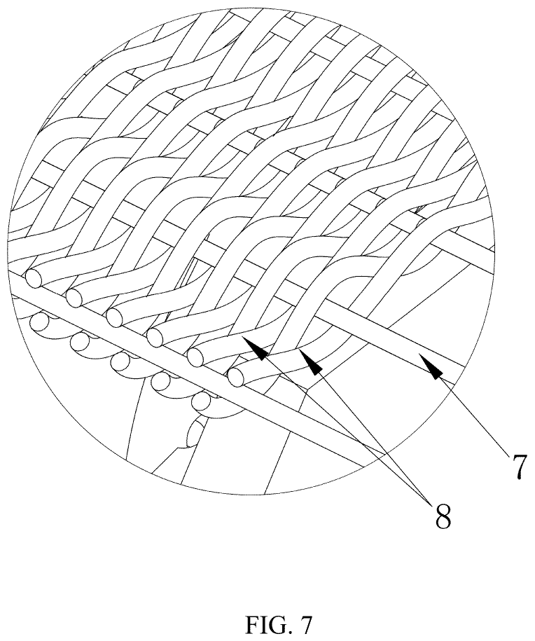

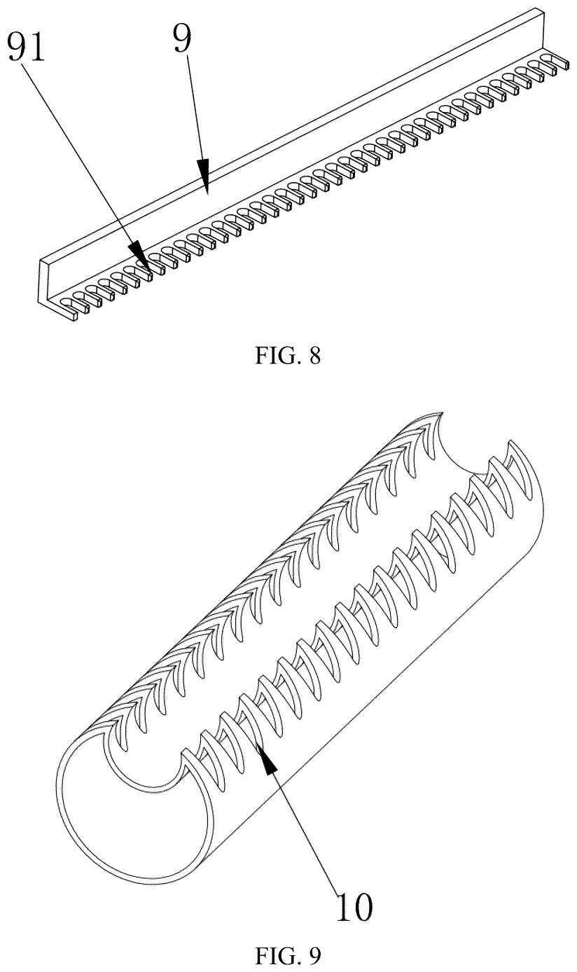

### DETAILED DESCRIPTION

The present disclosure is further described below in detail with reference to the accompanying drawings.

The present disclosure provides a manufacture method of a woven surface by a way of cleats attachment. The manufacture method comprises steps A-D. The step A comprises providing a frame 1, where an interior of the frame 1 is hollow to define a weaving area.

The step B comprises fixing a shaping mold on the frame 1, where a shaping surface of the shaping mold extends into the weaving area.

The step C comprises weaving the non-flat wove surface on the frame 1 by using weaving strips 2 and enabling a bottom portion of the non-flat wove surface being tightly attached to the shaping surface of the shaping mold.

The step D comprises disassembling the shaping mold after the non-flat wove surface is completely woven.

In one embodiment, the shaping mold comprises a positioning plate 4 and shaping plates 5 fixed to the positioning plate 4. Each two adjacent shaping plates 5 are spaced apart from each other. End surfaces of the shaping plates 5 are shaping base surfaces 6. The shaping base surfaces 6 of the shaping plates 5 jointly form the shaping surface of the shaping mold.

In one embodiment, in the step C, a vertical structure 7 perpendicular to an extending direction of the shaping plates is woven first, and then a parallel structure 8 parallel to the extending direction of the shaping plates is woven.

In one embodiment, the parallel structure and the vertical structure of the non-flat wove surface are woven together by a pick-press-weave method.

In one embodiment, in the step C, the weaving strips 2 wrap a main body of the frame 1.

In one embodiment, hook seats 10 are disposed on a bottom portion of the frame 1, and the weaving strips 2 are wound around the hook seats 10.

In one embodiment, through holes are defined in a bottom portion of the frame 1, and the weaving strips 2 pass through the through holes for weaving.

In one embodiment, a comb rack 9 is disposed on a bottom portion of the frame 1, and the weaving strips 2 are woven around teeth 91 on the comb rack 9.

In one embodiment, when weaving the parallel structure 8 of the non-flat wove surface, each of the weaving strips 2 of the parallel structure is woven between a gap defined by each two adjacent shaping plates 5.

The present disclosure provides the manufacture method of the wove surface. A core of the manufacture method is to provide the frame and fix the shaping mold on the frame, and the weaving strips are woven on the shaping mold, thereby realizing the non-flat wove surface of a three-dimensional shape. The manufacture method comprises following main steps.

First, the frame 1 is provided, the interior of the frame 1 is a hollow structure, so as to define a weaving area for weaving operations. A shape and a size of the frame are selected and adjusted according to a woven product to be produced, providing a stable support structure for a weaving process. The frame may be rectangular, circular, or other shapes, which is designed according to needs of furniture.

The shaping mold is fixed on the frame 1. A shape of the shaping mold determines a three-dimensional shape of the non-flat wove surface. The shaping surface of the shaping mold (i.e., a surface of the shaping mold that is attached to an inner side of the non-flat wove surface) extends into the weaving area of the frame. Under a guidance of the shaping mold, the weaving strips are woven according to a predetermined three-dimensional shape, which ensures that the non-flat wove surface closely fit the shaping surface during the weaving process to form an expected three-dimensional effect.

After the shaping mold is fixed, the weaving strips 2 are woven in the frame 1. The weaving strips wrap the main body of frame to gradually complete the weaving of the non-flat wove surface, or the weaving strips gradually complete the weaving of the non-flat wove surface through the hook seats, the comb rack, or other components disposed the bottom portion of the frame. During the weaving process, the weaving strips are woven along the shaping surface of the shaping mold, so that the bottom surface of the non-flat wove surface is closely attached to the shaping surface of the shaping mold. In this way, the non-flat wove surface accurately replicates a three-dimensional shape of the shaping mold.

In a specific operation, the weaving strips are configured to weave the vertical structure 7 perpendicular to the extending direction of the shaping plates firstly, and the weaving strips on the vertical structures roughly shape a shape of the non-flat wove surface, and then the weaving strips are configured to weave the parallel structure 8 parallel to the extending direction of the shaping plates. Such sequential weaving method ensures a natural and smooth transition of the non-flat wove surface. At the same time, through the weaving process such as “pick-press weave method”, the non-flat wove surface is made more structural and beautiful.

When the weaving process is completed, the non-flat wove surface has the desired three-dimensional shape. At this time, the final woven product is obtained by simply removing the shaping mold. Since the shaping mold provides shape support during the entire weaving process, no complicated post-processing operations are required.

Compared with the prior art, in the manufacture method of present disclosure, by fixing the shaping mold in the frame, the three-dimensional shape of the non-flat wove surface is accurately controlled. An existence of the shaping mold ensures that the weaving strips completely fit the shaping surface of the shaping mold during the weaving process, thereby forming the non-flat wove surface with an accurate three-dimensional shape after completion. Compared with conventional planar weaving technology, the present disclosure breaks through the two-dimensional limitation and achieves the weaving of complex three-dimensional shapes.

In addition, the manufacture method of present disclosure combines the weaving process and the molding processes, thereby simplifying an overall operation flow. By providing the shaping mold, a laying process of the weaving strips is effectively guided, reducing complexity of the manual operations. The non-flat wove surface is basically formed during the weaving process, omitting a need for subsequent adjustments and significantly improving production efficiency.

Furthermore, the shaping mold of the present disclosure may be designed into various shapes as required, so that the woven product is able to present rich and diverse three-dimensional shapes, which greatly enhances the aesthetics and market competitiveness of the woven product, while meeting consumers' demand for personalized and diversified products.

Moreover, the manufacture method is applicable to weaving strips made of different materials. The weaving strips may be made of natural materials such as rattan and bamboo strips, or the weaving strips are made of modern materials such as synthetic fibers. Therefore, the manufacture method is widely used in various fields, including productions of household items, decorations, and fashion accessories, which has strong adaptability. By an introduction of the shaping mold, the present disclosure greatly simplifies the complexity of the weaving process and reduces the requirements for the skills of the craftsmen. Further, since the shape of the non-flat wove surface is basically determined during the weaving process, subsequent processes are simplified, which is very suitable for large-scale production applications.

In summary, the present disclosure innovatively introduces the shaping mold into the weaving process, successfully solves problems of the lack of three-dimensional sense and low production efficiency of the conventional woven layer, and provides an efficient and flexible solution for the design and manufacture of the woven products.

The above shows and describes the basic principles and main features of the present disclosure and the characteristics of the present disclosure. Those skilled in the art should understand that the present disclosure is not limited by the above embodiments, and the above embodiments and descriptions are only for illustrating the principles of the present disclosure. Without departing from the spirit and scope of the present disclosure, the present disclosure may have various changes and improvements, which shall fall within the protection scope of the present disclosure.

What is claimed is:

1. A manufacture method of a woven surface by a way of cleats attachment, comprising:
a step A: providing a frame, wherein an interior of the frame is hollow to define a weaving area;
a step B: fixing a shaping mold on the frame, wherein a shaping surface of the shaping mold extends into the weaving area;
a step C: weaving a non-flat wove surface on the frame by using weaving strips, enabling a bottom portion of the non-flat wove surface being attached to the shaping surface of the shaping mold; and
a step D: disassembling the shaping mold after the non-flat wove surface is completely woven.

2. The manufacture method according to claim 1, wherein the shaping mold comprises a positioning plate and shaping plates fixed to the positioning plate, each two adjacent shaping plates are spaced apart from each other, end surfaces of the shaping plates are shaping base surfaces, and the shaping base surfaces of the shaping plates jointly form the shaping surface of the shaping mold.

3. The manufacture method according to claim 2, wherein in the step C, a vertical structure perpendicular to an extending direction of the shaping plates is woven first, and then a parallel structure parallel to the extending direction of the shaping plates is woven.

4. The manufacture method according to claim 3, wherein the parallel structure and the vertical structure of the non-flat wove surface are woven together by a pick-press-weave method.

5. The manufacture method according to claim 1, wherein In the step C, the weaving strips wrap a main body of the frame.

6. The manufacture method according to claim 1, wherein hook seats are disposed on a bottom portion of the frame, and the weaving strips are wound around the hook seats.

7. The manufacture method according to claim 1, wherein through holes are defined in a bottom portion of the frame, and the weaving strips pass through the through holes for weaving.

8. The manufacture method according to claim 1, wherein a comb rack is disposed on a bottom portion of the frame, and the weaving strips are woven around teeth on the comb rack.

9. The manufacture method according to claim 3, wherein when weaving the parallel structure of the non-flat wove surface, each of the weaving strips of the parallel structure is woven between a gap defined by each two adjacent shaping plates.
